(19) United States
(12) Patent Application Publication
(10) Pub. No.: US 2004/0132624 A1
(43) Pub. Date: Jul. 8, 2004

(54) Metal base material for oxide superconducting thick films and manufacturing method thereof

(76) Inventor: Mitsunobu Wakata, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 10/472,548

(22) PCT Filed: Dec. 10, 2001
(86) PCT No.: PCT/JP01/10794

(51) Int. Cl. H01B 1/00

(52) U.S. Cl. 505/100

(57) ABSTRACT

The present invention relates to a metal base material for oxide superconducting thick films, in which an NiO layer is formed on at least one surface of a plate-shaped, tape-shaped, rod-shaped or wire-shaped non-magnetic alloy. The base material can be obtained through a manufacturing method, including the steps of: introducing a composite metal base material having an Ni layer joined on at least one surface of a plate-shaped or tape-shaped non-magnetic alloy into a furnace having an oxidative atmosphere, and heating/maintaining the alloy for a given period of time; suspending the oxidation reaction; and heat-treating the composite metal base material under the vacuum or the inert, to thereby eliminate an Ni group ferromagnetic layer, and to uniformize a composition of a non-oxidized alloy layer.

### TECHNICAL FIELD

The present invention relates to a metal base material for oxide superconducting thick films such as an oxide superconducting wires, which are used for superconducting electrical energy transmission cables, superconducting magnets, current leads and a magnetic shielding material, etc, and the manufacturing method thereof.

### BACKGROUND ART

Bi-2223 phase and Bi-2212 phase are now on their way to becoming commercially practical as an oxide superconducting material. For example, according to an article of K. Inoue et al., “Advances in Superconductivity; Proceedings 9th International Symposium on Superconductivity (1996, Sapporo) 1463,” in an inner layer of a 21.1 T metal superconducting magnet obtained by 1.8 K cooling, a high temperature superconducting magnet of Bi-2212 phase obtained by 4.2 K cooling is hybridized to generate a magnetic field of 23.5 T. Also, according to an article of T. Kato et al., “Proceedings 10th International Symposiumon Superconductivity (1997, Gifu) 877,” high temperature superconducting magnet of Bi-2223 phase is cooled with a refrigerator, and generation of a magnetic field of 7 T at K is attained.

Of the high temperature superconducting wire used for those, a tape-shaped wire having a rectangular cross section is the mainstream. This tape-shaped wire is manufactured by, for example, a method which is named Powder-in-Tube (PIT) method. The method includes: filling an oxide superconducting material powder into a silver tube to manufacture a single core wire by wire drawing processing; and further gathering and bundling the multiple number of single core wires in a silver tube having a larger diameter to manufacture a multicore wire by the wire drawing processing. Heat treatment is performed thereto after the rolling processing is performed. According to another method, as shown in FIG. 7, the tape-shaped wire can be manufactured by a coating method in which the oxide superconducting material powder is mixed with an organic binder to prepare ink; the obtained mixture is applied to a silver tape; and optionally another process is combined thereto and heat treatment is subjected thereto. In FIG. 7, reference numeral 1′ denotes a silver base material, and numeral 4 denotes a superconducting layer. In this coating method, attempts are being made for applying ink by the various kinds of methods such as dip coating, screen printing, and doctor blade. Also, the tape-shaped wire is subjected to an orientation technology in which a c-axis of a crystal of an oxide superconductor is aligned with a perpendicular direction of a tape surface, so that a superconducting electric current is easily allowed to flow in a longitudinal direction of the tape.

As the oxide superconducting materials, various materials such as Tl-based materials, Y(Nd)-based materials are investigated other than the Bi-based materials described above. Further, the wire is not limited to the tape shape, and a round wire structure, a rectangular shape structure, and the like are examined.

In the production of such wires, silver is used as a base material because the silver has functions of being superior in workability; not reacting with an oxide superconducting material having high reactivity; orientating the oxide superconducting material; and allowing oxygen to pass therethrough to some extent. In a cross section of the wire in FIG. 7, a ratio of a cross-sectional area of the silver to a cross-sectional area of the oxide superconducting material is called a silver ratio. For the silver ratio, a value of about 2 or more is adopted from the viewpoint of workability.

High magnetic field applications such as an application to NMR are examined for the oxide superconducting wire, because critical current density (J_{c}) is higher than that of metal wires at 4.2 K even in a high magnetic field of more than 20 T. Further, the oxide superconducting wire has a high critical temperature (T_{c}), so that it is possible to generate a magnetic field of about 7T even at a temperature of about 20 K. On this account, it is expected that the oxide superconducting wire is to be practically used as a superconducting magnet, which is less in its operation cost than that of the metal-based wire. Furthermore, an oxide superconducting wire having a substantial J_{c} even at liquid nitrogen temperature in a weak magnetic field is also being developed. Accordingly, its application to a power transmission line is also expected.

According to an article of Y. Iwasa, “IEEE Trans. on Mag., Vol. 24, No. 2 (1988) ¹²¹I,” when the oxide superconducting wire is used at, for example, 77 K, the specific heat of the oxide superconducting material is extremely high compared to a value thereof at 4.2 K. Although the silver ratio is necessary to some extent from the viewpoint of protection, even if the silver ratio is 0, it does not matter from the viewpoint of stabilization. The operation temperature of about 20 K or more is similar thereto. Therefore, (1) the silver ratio is required to be decreased to reduce the manufacturing cost of the wire. Besides, the mechanical strength of silver is low. As a result, the wire cannot withstand a high electromagnetic force generated by a high magnetic field magnet or a large-sized magnet. Accordingly, (2) mechanical reinforcement of a wire is also an important technical problem to be solved.

In recent years, a wire manufacturing method was proposed, in which silver is not used at all, and the coating method is used. According to an article of “Kono et al., “Proceedings on 61st Meeting on Cryogenics and Superconductivity, 1999, p159,” it is reported, as shown in FIG. 8, that if Ni tape is oxidized at high temperature to form on its surface an oxide layer having a thickness of several tens micrometers, on which Bi-2212 layer is formed by the coating method, a c-axis of Bi-2212 phase is orientated perpendicularly to the tape surface similar to the case where silver was used as a base material, and the critical current density of 120,000 A/cm² was obtained at 4.2K in 10 T. In FIG. 8, reference numeral 1 denotes Ni base; numeral 3 denotes Ni oxide layer formed by the high temperature oxidation; and numeral 4 denotes a superconducting layer.

The above-mentioned wire does not need silver, thereby being capable of lowering the manufacturing cost thereof, and attaining a high strength wire. However, since non-oxidized Ni is a strong magnetic substance, limitation of its application is generated. That is, there are problems in that a remaining magnetic field is high, an AC loss is large, and the like.

It is an object of the present invention to solve the problems with the conventional technology described above, and in particular to provide a metal base material for oxide superconducting thick films, having a low manufacturing cost, high strength, and non-magnetism.

### SUMMARY OF THE INVENTION

According to the present invention, there is provided a metal base material for oxide superconducting thick films, characterized in that an NiO layer is formed on at least one surface of a plate-shaped, tape-shaped, rod-shaped or wire-shaped non-magnetic alloy.

Further, according to the present invention, there is provided the metal base material for oxide superconducting thick films, characterized in that the non-magnetic alloy contains as main components copper and nickel, and the nickel content is 10 wt. % or more and 49 wt. % or less.

Further, according to the present invention, there is provided the metal base material for oxide superconducting thick films, characterized in that the non-magnetic alloy contains as the main components nickel and chromium, and the chromium content is 10 wt. % or more and 25 wt. % or less.

Further, according to the present invention, there is provided the metal base material for oxide superconducting thick films, characterized in that the non-magnetic alloy contains tungsten as the main component.

Further, according to the present invention, there is provided the metal base material for oxide superconducting thick films, characterized in that the non-magnetic alloy contains the copper—nickel alloy, the nickel—chromium alloy, the alloy including tungsten, molybdenum, manganese, and vanadium at arbitrary ratios.

Further, according to the present invention, there is provided the metal base material for oxide superconducting thick films, characterized in that a content of iron in the non-magnetic alloy is less than 0.1 wt. %.

Besides, according to the present invention, there is provided a first manufacturing method for a metal base material for oxide superconducting thick films, characterized by comprising the steps of: (1) introducing a composite metal base material having an Ni layer joined on at least one surface of a plate-shaped, tape-shaped, rod-shaped or wire-shaped non-magnetic alloy into a furnace having an oxidative atmosphere, and heating/maintaining the alloy for a given period of time to subject the Ni layer to an oxidation reaction; (2) cooling the composite base material or changing the atmosphere into a vacuum or an inert atmosphere, to thereby suspend the oxidation reaction; and (3) after the step (2), heat-treating the composite metal base material under the vacuum or the inert, to thereby eliminate an Ni group ferromagnetic layer, and to uniformize a composition of a non-oxidized alloy layer.

Further, according to the present invention, there is provided a second manufacturing method for a metal base material for oxide superconducting thick films, characterized by comprising the step of: introducing a composite metal base material having an Ni layer joined on at least one surface of a plate-shaped, tape-shaped, rod-shaped or wire-shaped non-magnetic alloy into a furnace having an oxidative atmosphere, and heating/maintaining the alloy for a period of time so that the Ni layer is entirely oxidized.

Further, according to the present invention, there is provided the first or the second manufacturing method for a metal base material for oxide superconducting thick films, characterized in that the composite metal base material before being subjected to heat treatment is an Ni clad non-magnetic alloy.

Further, according to the present invention, there is provided the first or the second manufacturing method for a metal base material for oxide superconducting thick films, characterized in that the composite metal base material before being subjected to heat treatment is an Ni and Ni poor non-magnetic alloy clad non-magnetic alloy.

Moreover, according to the present invention, there is provided the metal base material for oxide superconducting thick films, characterized in that the non-magnetic alloy is coated with a ceramics powder collective layer, and the ceramics powder collective layer is further coated with an NiO layer.

Furthermore, according to the present invention, there is provided a third manufacturing method for a metal base material for oxide superconducting thick films, characterized by comprising the steps of: inserting a non-magnetic alloy rod into an Ni tube; filling ceramics particles between the Ni tube and the non-magnetic alloy rod; processing the composite rod into a targeted shape so that a cross-sectional area of the composite rod is gradually decreased; forming a composite having an Ni layer on its surface; and subjecting the composite to high temperature oxidization to oxidize the entire of the Ni layer.

According to the structure of the present invention described above, a metal base material for oxide superconducting thick films can be provided, which is non-magnetic, high in its strength, and low in its production cost.

### DISCLOSURE OF THE INVENTION

A metal base material for oxide superconducting thick films of the present invention has such a feature that an NiO layer is formed on at least one surface of a plate-shaped, tape-shaped, rod-shaped or wire-shaped non-magnetic alloy.

As a method of forming an NiO layer on a surface of the non-magnetic alloy, it is conceivable to oxidize a Ni-clad or coated non-magnetic alloy such as a stainless steel, a Ni based alloy and so on, at high temperature and then turn all the Ni layer into NiO. However, diffusion of metal element in the non-magnetic alloy to the Ni layer cannot be avoided under normal heat treatment. Actually, an x-ray diffraction pattern of the surface of Ni clad SUS304 board, which was heated to 950° C. in air and maintained for 10 hours followed by cooling, clearly exhibited a multi phase state, and the formation of a single phase of NiO was unavailable. It is supposed that diffusion starts at a low temperature than that in the oxidation, and metal components in SUS304 (mainly, iron) diffuse closely to the surface when the oxidation starts. As the result of investigation to avoid this, the present invention reaches to find out three kinds of methods.

The first method relates to a method to prevent inter diffusion. It is desirable if a diffusion prevention layer can be formed between the non-magnetic alloy and Ni, but no appropriate metal or an alloy can be found as the diffusion prevention layer. On the other hand, diffusion coefficients of metal elements to ceramics materials are extremely small. According to one aspect of the present invention, there is provided a metal base material for oxide superconducting thick films in which a metal base having a ceramics layer formed between a non-magnetic alloy and an Ni layer is subjected to high temperature oxidization to oxidize all the Ni layer.

Specifically speaking, the third method relates to a manufacturing method for a metal base material for oxide superconducting thick films, including the steps of: inserting a non-magnetic alloy rod into an Ni tube; filling ceramics particles between the Ni tube and the non-magnetic alloy rod; processing the composite rod into a targeted shape so that a cross-sectional area of the rod is gradually decreased; and oxidizing the entire of the Ni surface layer by high temperature oxidization. The obtained metal base material has a structure in which the non-magnetic alloy is coated with a ceramics powder collective layer, and then the ceramics powder collective layer is coated with the NiO layer.

Another method relates to a method in which interdiffusion and oxidation are simultaneously carried out. If the interdiffusion and oxidation are simultaneously carried out to a joining system between the non-magnetic alloy and Ni, the NiO layer grows on the Ni surface. Besides, from a portion near the joint portion, interdiffusion between the non-magnetic alloy and the Ni layer begins. If oxidation reaction is suspended at a stage where a required thickness of the NiO layer has been attained, only the interdiffusion between the non-magnetic alloy and Ni proceeds, resulting in attaining a homogeneous composition of the non-magnetic alloy. On the other hand, the diffusion of metal components contained in the non-magnetic alloy into the generated NiO layer is hardly occurred, so that there can be obtained a structure in which the NiO layer is laminated on the homogeneous non-magnetic alloy. In this first method, the non-magnetizing heat treatment performed by the homogenization of an alloy composition after the oxidizing heat treatment can be shorten in its time period by performing, under a vacuum or an inert gas atmosphere, the heat treatment at the higher temperature than that of the oxidation heat treatment temperature.

In the above-mentioned first method, it is conceivable to employ a method in which the entire Ni layer of the composite metal base material is oxidized at the oxidation processing temperature of Ni, in which Ni layer having a minimum thickness is coated on the non-magnetic alloy consisting of the metal component whose diffusion coefficient with Ni is small. On the surface of the base material, an NiO layer having a necessary thickness is formed after the oxidation. The thin diffusion layer is formed on a joint portion between the non-magnetic alloy and Ni, but an Ni rich alloy phase is also oxidized. As a result, if the composite oxide layer being thin is formed, it is non-magnetized. Therefor, in the present second method, the non-magnetizing heat treatment performed by the homogenization of an alloy composition after the oxidation heat treatment, which was necessary in the first method, becomes unnecessary.

Further, according to another aspect of the present invention, the present invention is directed to employment of a Cu—Ni alloy as the non-magnetic alloy. This system forms solid solution in all composition, and Neel temperature of magnetic susceptibility monotonously decreases in accordance with an increase in Cu content from 354.4° C. of Ni, and magnetic susceptibility disappears at about 44 at. % Ni (42 wt. % Ni) or less. When estimating from the data of 0° C. or more, it can be estimated that non-magnetism appears at 46 at. % Ni or less (44 wt. % Ni or less) in case of 20 K or more, and the non-magnetism appears at 51 at. % Ni or less (49 wt. % Ni or less) in case of 77 K or more. Further, the interdiffusion rate of Ni—Cu is slow enough as compared with the oxidation rate of Ni at temperature of about 950° C. Note that, to proved a high strength thereto, it is preferable that the Ni content is 10 wt. % or more.

Further, according to another aspect of the present invention, the present invention is directed to employment of an Ni—Cr alloy as the non-magnetic alloy. This system shows magnetic susceptibility at less than about 10 wt. % Cr. Besides, there are problems in that not only solid solution is hardly obtained, but also workability is inferior at above about 25 wt. % Cr. Further, the interdiffusion rate of Ni—Cr is slow enough as compared with the oxidation rate of Ni at temperature of about 950° C.

Further, according to another aspect of the present invention, the present invention is directed to employment of an alloy containing as a main component tungsten as the non-magnetic alloy. Note that, according to the present invention, there is employed an alloy containing at arbitrary ratios the Cu—Ni alloy, Ni—Cr alloy, and an alloy containing W as a main component; molybdenum; manganese; and vanadium at an arbitrary ratio.

Note that, if a large quantity of iron is included in the non-magnetic alloy, iron easily diffuses to the Ni surface by grain boundary diffusion from low temperature. Therefore, the iron content in the non-magnetic alloy is preferably less than 0.1 wt. %.

Further, according to another aspect of the present invention, the present invention is directed to a manufacturing method in which an Ni clad non-magnetic alloy is used as a composite metal base material before heat treatment.

Further, according to another aspect of the present invention, the present invention is directed to a manufacturing method in which an Ni and Ni poor non-magnetic alloy clad non-magnetic alloy is used as a composite metal base material before heat treatment.

According to the present invention, the metal base material for oxide superconducting thick films can be obtained, with which the reinforced wire can be obtained without deteriorating the superconducting characteristics; the reduction of the manufacturing cost of the wire can be also attained because the silver base material is not used; and in addition, which is non-magnetism.

### BRIEF DESCRIPTION OF THE DRAWINGS

FIG. 1 is a view for explaining a method in accordance with Embodiment 2.

FIG. 2 and FIG. 3 are views for explaining other modes of Embodiment 2.

FIG. 4 is a view for explaining Embodiment 3 of the present invention.

FIG. 5 is a view for explaining a method in accordance with Embodiment 1.

FIG. 6 is a view showing a structural change in a metal base material during a heat treatment process in Embodiment 2.

FIG. 7 is a cross sectional view for explaining a conventional metal base material for oxide superconducting thick films using a silver base metal.

FIG. 8 is a cross sectional view for explaining a conventional metal base material for oxide superconducting thick films having an Ni oxide layer on its surface.

### EMBODIMENTS

Hereinafter, the present invention will be further described by using embodiments.

Embodiment 1

First, there are prepared: an Ni tube having an outer diameter of 12 mm, an inner diameter of 11 mm, and a length of 500 mm; a Cu-40 wt. % of Ni alloy rod having an outer diameter of 10 mm and a length of 490 mm; alumina powder having an average particle size of 0.05 μm; and a Cu tape having a thickness of 0.45 mm rolled from a Cu wire having a diameter of 1 mm. On one end of the Cu—Ni alloy rod is spirally closely wrapped with the Cu tape to insert in the Ni tube, and the several Cu tapes are inserted in a gap between the Ni tube and the Cu—Ni alloy rod at the other end with portions of the gap remaining. The gap between the Ni tube and the Cu—Ni alloy rod are filled with the alumina powder. About 16% alumina powder having the most filling density can be filled. The Cu tapes at the other end are removed and the ends are sealed with fused solder. The resultant wire is processed to have an outer diameter of 2.0 mm by swaging processing and drawing processing. As a result of the cross sectional observation, the thicknesses of the circumferential Ni layer and the alumina layer were about 80 μm and 15 μm, respectively. This round wire is processed by rolling to have a tape shape and a thickness of 0.2 mm. The thicknesses of the Ni layer and the alumina layer at the center of the tape are about 8 μm and 2 μm, respectively, and the width of the tape is about 5 mm. The present tape was subjected to heat treatment at 950° C. in air for 20 hours. As results of surface X ray diffraction and cross sectional composition analysis, there was no change except that the overall Ni layer was turned into an NiO layer, and the thickness of the NiO layer was about 25 μm. The obtained tape was cut off to have a length of 40 mm, thereby forming a metal base material for oxide superconducting thick films.

Bi₂O₃, SrCO₃, CaCO₃, and CuO, which are raw material powders of the superconducting material, are combined and mixed at a ratio of Bi:Sr:Ca:Cu=2:2:1:2 (molar ratio). This is a composition to be a superconductor including Bi-2212 phase as a main component upon heat treatment. The mixture powder is pressed into pellets at 600 kgf/cm², to form a green compact. This green compact was preheated at 680° C. in air for 10 hours, and then ground and molded. After that, the molded green compact was again subjected to heat treatment at 730° C. for another 10 hours and then crushed. The obtained powder was mixed with an organic binder, thereby forming ink for screen printing concerning screen printing, for example, “New Publication Screen Printing Handbooks” (published by Japanese Screen Printing Technology Association, 1988) and the like have detailed descriptions thereof, which will be thus omitted here.

The ink was applied to the metal base material for oxide superconducting thick films by screen printing, and pressed and molded under a pressure of 4t/cm², after debinder processing at 450° C. in air for 1 hour. After heating at the highest temperature 890° C. and then gradually cooling to 870° C. for 4 hours, the furnace was cooled to room temperature. For comparison, a sample in which an oxide superconducting ink was applied on a silver tape having a length of 40 mm, a thickness of 0.2 mm, and a width of 5 mm by screen printing was simultaneously heat-treated.

The orientation of the Bi-2212 phase obtained by X ray diffraction, the superconducting characteristics such as critical current, and their variations have in particular no difference between the case of using an Ag base material and the case of using the metal base material of this embodiment. Also, from comparisons of the magnetic field dependence and the temperature dependence of magnetization, no component showing magnetic susceptibility is contained in the metal base material of this embodiment.

FIG. 5 is a view for explaining a method of Embodiment 1. FIG. 5(a) shows a composite round wire, FIG. 5(b) shows a tape manufactured therefrom by across section decreasing process and a rolling process, FIG. 5(c) shows a metal base material for oxide superconducting thick films of this embodiment in which the tape is oxidized at a high temperature, and FIG. 5(d) shows the metal base material having a superconducting layer formed thereon. In the figures, reference numeral 1 denotes Ni; 2, a non-magnetic alloy; 3, an Ni oxide layer; 4, the superconducting layer; and 5, a ceramics powder layer.

Embodiment 2

First, the oxidation rate at 950° C. in air of the Ni tape was obtained. The weight change of the sample maintained at 950° C. for to 25 hours was obtained. The relationship between time t (sec) and thickness x (cm) of the oxidized Ni layer supposing that the oxidation reaction is Ni+(½)O₂->NiO is as follows:

x²=2D₁t (1)

and it is understood that D₁=6.9×10⁻¹² cm²/sec.

On the other hand, the relationship between metal diffusion distance x (cm) and time t (sec) is as follows:

x²=2Dt (2)

where D is a diffusion coefficient, and it is known that D has the following temperature dependence:

D=D₀ exp[−Q₀/RT] (3)

For example, the diffusion coefficients of Cu and Fe into Ni at 950° C. were 7.8×10⁻¹² cm²/sec and 3.5×10⁻¹² cm²/sec, respectively. It is understood that the diffusion rate and oxidation rate of Ni were on the same order.

Here, a Cu-15 wt. % Ni alloy rod having an outer diameter of 9.22 mm and a length of 500 mm is inserted in an Ni tube having an outer diameter of 12 mm, an inner diameter of 10 mm, and a length of 500 mm. The resultant wire is processed to have an outer diameter of 2.33 mm by a cross section decreasing process. The thickness of the Ni layer at this time is about 208 μm. This was rolled and processed to have a thickness of 0.38 mm to obtain a composite tape. The thickness of the Ni layer in the final shape is about 34 μm and the width of the tape is about 4.6 mm (at the center).

It is estimated from the oxidation rate of Ni that about 7.1 μm of Ni is oxidized at 95°° C. in air for 10 hours. Also, it is estimated from the diffusion rate of Cu into Ni that Cu is diffused in about 7.5 pm of Ni layer by heat treatment at 950° C. for 10 hours. Then, one part of the composite tape was introduced into a furnace heated at 950° C. in air, and maintained for 10 hours. At the time when the maintenance time passed 10 hours, an atmosphere in the furnace was evacuated by a vacuum and then the furnace was gradually heated up to 1300° C., maintained for 15 hours, and then cooled.

According to the X-ray diffraction evaluation, the X-ray diffraction pattern of the surface of the obtained sample perfectly matched that of NiO. Also, as a result of the cross sectional observation, the thickness of the circumferential oxide layer was about 23 μm. Theoretically, when Ni is oxidized to form NiO, the thickness thereof becomes 1.52 times. Therefore, when Ni having a thickness of 7.1 μm is oxidized, the thickness of the Nio layer becomes 10.8 μm. The oxide layer having about 2 times the thickness as that predicted shows that the layer is considerably porous. Furthermore, as a result of investigating the composition distribution of the alloy layer, Cu and Ni were considerably evenly distributed, and the concentration of Ni was about 40 wt. %.

As a result of investigating the temperature dependence of magnetic susceptibility of the obtained base material from 4.2 K to room temperature, a sign of magnetic susceptibility was not found and non-magnetism was exhibited.

The oxide superconducting ink identical to that of Embodiment 1 is used for printing on this base material, and it is heat-treated under the condition identical to that of Embodiment 1.

The orientation of the Bi-2212 phase by X ray diffraction, the superconducting characteristics such as critical current, and their variations when the metal base material of this embodiment is used have in particular no difference between the case of using the Ag base material and the case of using the metal base material of Embodiment 1. Note that, the critical current in 0T at 4.2 K of the sample of this embodiment having an Ag foil for an electrode coated over its surface was 820A, and the critical current density was 5,084 A/mm² because the thickness of the oxide layer was 35 μm.

Note that it became clear that an appearance of a liquid phase is mainly contributed to a homogenization of an alloy composition than a diffusion phenomenon.

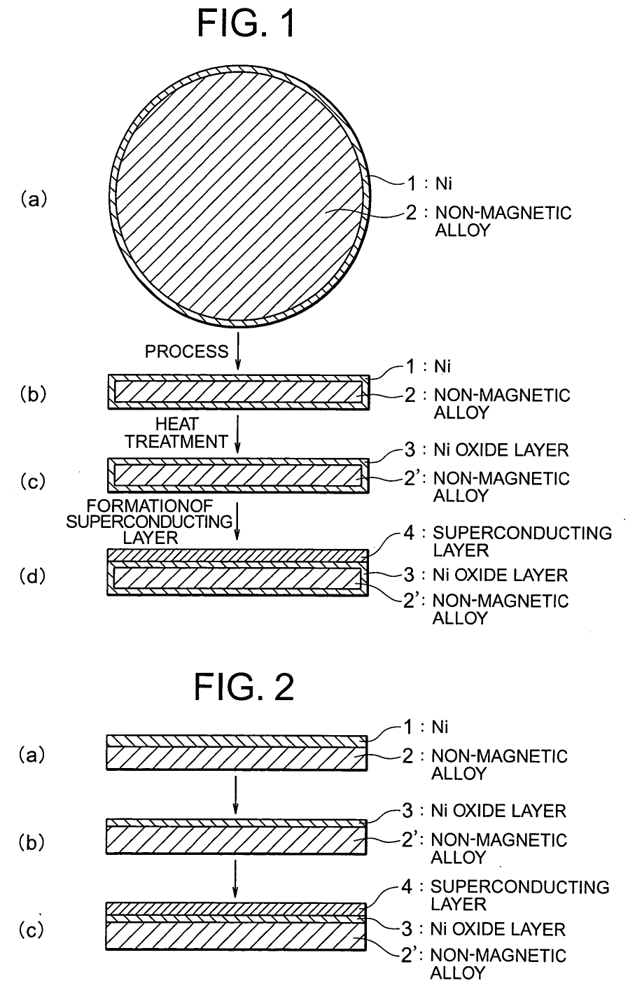

FIG. 1 is a view for explaining a method of this embodiment. FIG. 1(a) shows a composite round wire, FIG. 1(b) shows a tape manufactured therefrom by a cross section decreasing process and a rolling process, FIG. 1(c) shows a metal base material for oxide superconducting thick films of this embodiment in which the tape is oxidized at a high temperature and diffusion heat-treated, and FIG. 1(d) shows the metal base material having the superconducting layer formed on the metal base material. In FIG. 1, reference numeral denotes Ni; 2, a non-magnetic alloy; 2′, a non-magnetic alloy after diffusion; 3, an Ni oxide layer; and 4, the superconducting layer.

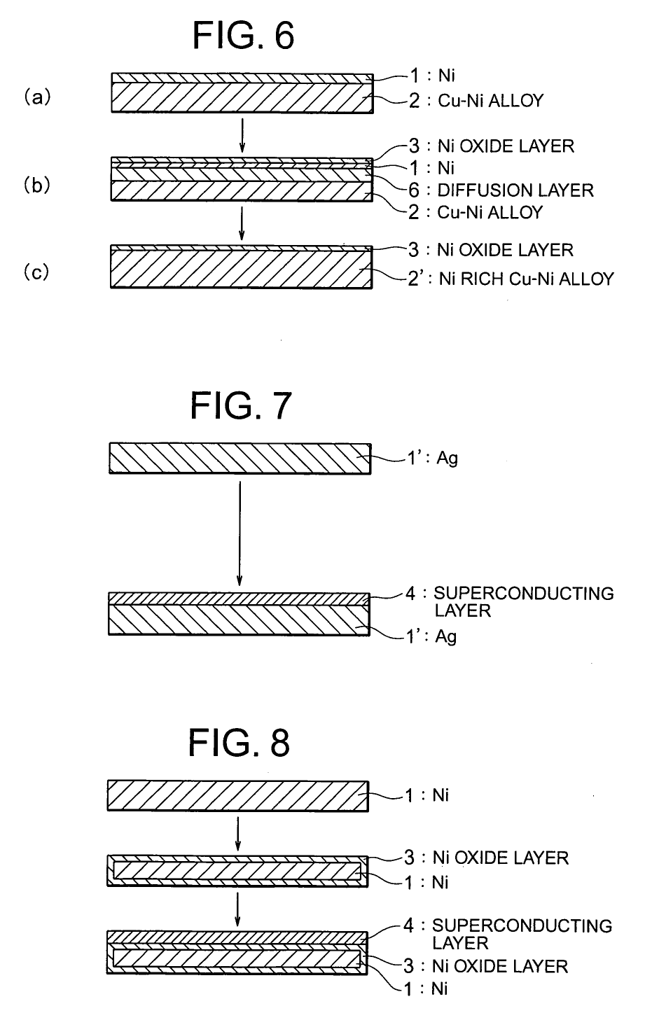

FIG. 6 is a view showing a structural change in the metal base material during a heat treatment process in Embodiment 2. FIG. 6(a) is a cross sectional view of the tape before heat treatment. The structure after this tape is introduced into a heated oxidation atmosphere furnace and a predetermined time has passed is shown in FIG. 6(b). In FIG. 6(b), reference numeral 3 denotes an oxide layer of Ni formed on its surface; 6, a diffusion layer with an alloy of Ni and non-magnetic; 1, a non-oxidized/non-dispersed Ni layer; and 2, an non-dispersed non-magnetic alloy layer. After that, the oxidative atmosphere is replaced with a vacuum or an inert atmosphere, and the cross sectional structure after maintained for a long period of time is shown in FIG. 6(c). In the figure, reference numeral 2′ denotes Ni-rich alloy layer generated by an alloy and diffusion with Ni.

In this embodiment, though a tape in which Ni is coated onto the entire surface of the non-magnetic alloy is used, it is not necessary to coat Ni on the entire surface. FIG. 2 is a view explaining another example in this embodiment. As shown in FIG. 2(a), the tape or plate with only one side coated with Ni is easily produced by rolling junction. The cross sectional structure shown in FIG. 2(b) is obtained by performing similar heat-treatment thereon. Next, as shown in FIG. 2(c), a superconducting layer 4 may be formed on an Ni oxide layer.

In this embodiment, the heat-treatment at 950° C. in air for 10 hours is described as an example as the high-temperature oxidation of Ni, but it is not limited to this. Actually, the formation of Bi-2212 thick film is possible on the base material subjected to heat-treatment at 950° C. in air for 1 or 4 hours. In this case, thicknesses of oxidized Ni (thickness of the formed NiO layer) for each case are estimated to take 2.25 μm (7.3 μm) and 4.5 μm (14.5 μm), respectively. Also, the oxidation heat-treatment temperature can be also selected, for example, in the range of 875° C. to 975° C. and at this time, heat-treatment may be performed while selecting the time period therefor that is enough to form the NiO layer with a thickness of about 7 μm or larger.

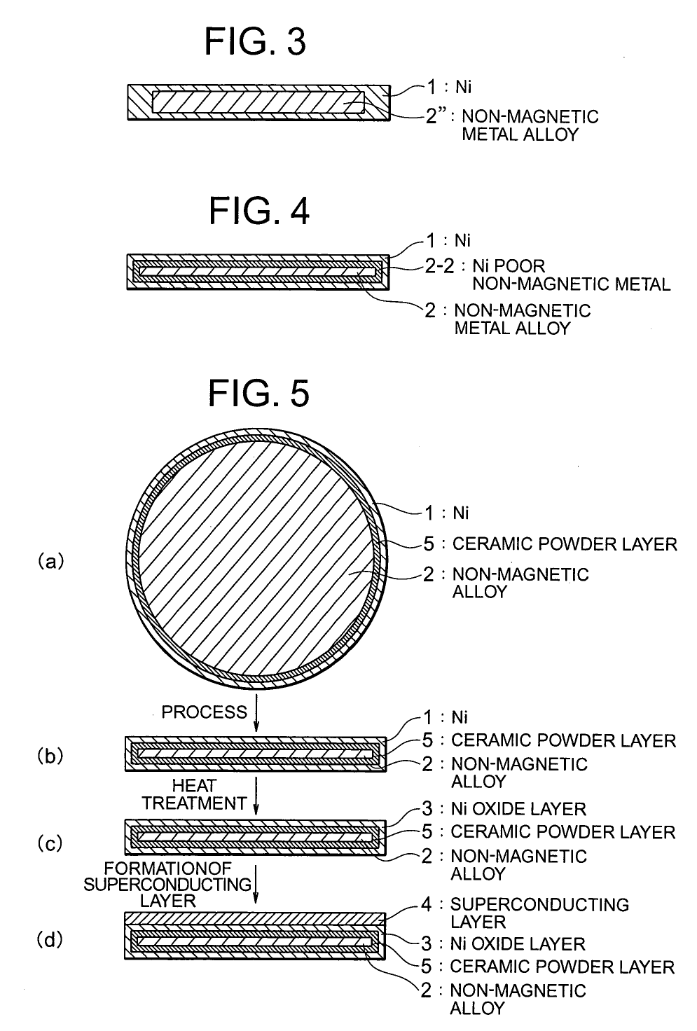

Also, in this embodiment, the Cu—Ni alloy is used, but it is not limited to this alloy. Actually, as will be also explained in the following embodiments, an Ni—Cr alloy can be applied and furthermore, other alloys including the metal that is hardly diffused into Ni can be applied. Furthermore, instead of alloy, even the pure metal or metal including many impurities that are hardly diffused into Ni can be used without any problem. In this case, as shown in FIG. 3, it is necessary to make the thickness of the Ni layer larger than that of FIG. 1. In FIG. 3, denoted by 2″ is another non-magnetic metal. For example, if copper is used as metal, the metal base material for oxide superconducting thick films having all the same structure as that of this embodiment can be obtained.

Furthermore, in this embodiment, though the example in which the atmosphere is evacuated has been explained as an interruption method of oxidation reaction, it is not definitely limited to this. Then, even a method of exchanging the atmosphere for an inert atmosphere, or a method of taking it out of a furnace after cooling or a method of performing rapid cooling is effective. The heat-treatment for disappearing the ferromagnetic layer upon cooling and the heat-treatment for homogenization of the alloy layer may be performed separately, in a vacuum or inert atmosphere.

Moreover, in this embodiment, though as the heat-treatment for disappearing the ferromagnetic layer and for the homogenization of the non-magnetic alloy layer, heat-treatment at 1300° C. in a vacuum for 15 hours is performed, it is not definitely limited to this. It is sufficient that the heat-treatment is performed for a time period or more during which the ferromagnetic layer disappears, and a concentration gradient in the alloy layer may be somewhat left. Also, it is effective to increase heat-treatment temperature in order to shorten heat-treatment time. However, a sufficient consideration is necessary for heating rate because a liquid phase appears in the above-mentioned heat-treatment. Embodiment 3.

In the Ni tube having an outer diameter of 12 mm and an inner diameter of 10 mm with a length of 500 mm, the Cu tube having an outer diameter of 9.8 mm and an inner diameter of 7.7 mm with a length of 500 mm and the Cu-40 wt. % of Ni alloy rod with an outer diameter of 7.5 mm and a length of 500 mm are inserted to perform process of decreasing the size in section down to 2.0 mm in the outer diameter. The thicknesses of an Ni layer and a Cu layer at this time were about 175 μm and 185 μm, respectively. This underwent rolling process to have a thickness of 0.2 mm to thereby obtain a composite tape. The thicknesses of the Ni layer and the Cu layer in the final shape were about 17.5 μm and 18.5 μm, respectively and the width of the tape was about 5 mm (a core). This cross sectional structure is shown in FIG. 4. In the figure, denoted by 2-2 is an Ni-poor non-magnetic alloy and it is defined as pure Cu in this embodiment.

This composite tape was introduced into the furnace heated up to 950° C. in aire and held for 10 hours. At the time when the holding time has reached 10 hours, the atmosphere inside the furnace is evacuated and the furnace is gradually heated up to 1300° C. and maintained for 5 hours, followed by cooling the furnace.

When the surface of the obtained metal base material was evaluated through X-ray diffraction, a complete correspondence with a pattern of NiO was observed. Also, as a result of the observation in section, the thickness of the oxide layer constituting the surface was about 23 μm. Furthermore, as a result of investigating composition distribution of the alloy layer, Cu and Ni exhibited considerably uniform distribution and the concentration of Ni was about 40 wt. %.

As a result of investigating temperature dependence of magnetic susceptibility of the obtained metal base material while the temperature ranged from 4.2K to room temperature, a sign of magnetic susceptibility was not found and the base material exhibited the non-magnetic property.

The oxide superconducting ink identical to that of Embodiment 1 was printed onto this base material, and the printing and heat treatment were performed under the same conditions as those of Embodiment 1. The orientation of the Bi-2212 phase obtained through X-ray diffraction, the superconducting characteristics of critical current etc., or its dispersion when using the metal base material of this embodiment had no particular difference with the cases of using the metal base material as in Embodiments 1 and 2 and the case of using the Ag base material.

In this embodiment, the diffusion distance for homogenization of the non-magnetic alloy layer is reduced to about 1/10 of that in Embodiment 2, so that the time period for heat treatment can be largely shortened.

Embodiment 4.

A metal tape in which Ni of about 3 μm in thickness was plated onto an Ni-20 wt. % Cr tape with a width of 5 mm and a thickness of 20 μm was prepared. This was cut into a plurality of tapes each having a length of 40 mm, which were put into the furnace heated up to 950° C. in air, and the furnace was cooled after maintaining them for 2 hours.

As a result of investigating the temperature dependence of the magnetic susceptibility of the obtained metal base material while the temperature ranged from 4.2 K to room temperature, a sign of magnetic susceptibility was not found and the base material exhibited the non-magnetic property.

An oxide superconducting ink identical to that of Embodiment was printed onto this base material and heat treatment was performed under the same conditions as those of Embodiment 1.

The orientation of Bi-2212 phase obtained through the X-ray diffraction, the superconducting characteristics of critical current etc., or its dispersion, when using the metal base material of this embodiment had no particular difference with the cases of using the metal base material of Embodiments 1, 2, and 3 and the case of using the Ag base material.

Embodiment 5.

A metal tape in which Ni of about 3 μm in thickness was plated on a Nichrome tape having a width of 5 mm and a thickness of 20 μm was prepared. This was cut into a plurality of tapes each having a length of 40 mm, which were put into the furnace heated up to 950° C. in air, and the furnace was cooled after maintaining them for 2 hours. The composition of Nichrome alloy (wt. %) is shown in Table below.

| Ni | Cr | Si | Fe | Mn | C |
|---|---|---|---|---|---|
| 78.63 | 19.50 | 1.23 | 0.60 | 0.02 | 0.02 |

An oxide superconducting ink identical to that of Embodiment 1 was printed onto this metal base material, and heat treatment was conducted under the same conditions as those of Embodiment 1.

In the obtained sample, Bi-2212 phase could not be formed and in addition, the metal base material was changed into ceramic. As a result of X-ray diffraction of the base material whose surface was subjected to the oxidation heat treatment, phases other than NiO were included therein and it was found that the iron contained in the base material caused those phases.

Embodiment 6.

A metal tape in which Ni of about 3 μm in thickness was plated on a W tape having a width of 5 mm and a thickness of 20 μm was prepared. This was cut into a plurality of tapes each having a length of 40 mm, which were put into the furnace heated up to 950° C. in air, and the furnace was cooled after maintaining them for 2 hours.

As a result of investigating the temperature dependence of the magnetic susceptibility of the obtained base material while the temperature ranged from 4.2 K to room temperature, a sign of magnetic susceptibility was not found, and the base material exhibited the non-magnetic property.

An oxide superconducting ink identical to that of Embodiment 1 is printed onto this base material, and heat treatment was conducted under the same conditions as those of Embodiment 1.

The orientation of Bi-2212 phase obtained through X-ray diffraction, the superconducting characteristics of critical current etc., or its dispersion when using the metal base material of this embodiment had no particular difference with the cases of using the metal base material of Embodiments 1 to 4 or the case of using the Ag base material.

In Embodiments 4 and 6, it has been described that the Ni—Cr alloy or W metal is effective as the non-magnetic high-strength alloy as well as plating is useful as a cladding method of Ni. Thus, the thickness of the base material or NiO layer can be reduced. Accordingly, it is effective for improvement of a volume fraction of the superconducting layer to be formed. Also, by reducing the thickness of the Ni layer, any non-oxidized Ni is not left, so that the base material can obtain the non-magnetic property and it is effective for omitting the additional heat treatment process for achieving the non-magnetic property.

Vanadium, molybdenum, manganese, or the like is also known as another non-magnetic metal element having a small diffusion coefficient into Ni at the temperature of around 950° C. Thus, it is needless to say that as the non-magnetic alloy, not only the Cu—Ni alloy, Ni—Cr alloy, and W group alloy but also these metals and an alloy containing these metals in an arbitrary ratio are effective. When a composite base material is used in which Ni is clad with a small thickness on such a non-magnetic alloy containing only the element having a small diffusion coefficient into Ni, the non-magnetic property can be achieved in such a manner that any non-oxidized Ni is not left. Thus, it is effective for omitting the additional heat treatment process for achieving the non-magnetic property.

In not a few cases, a heat-resistant alloy slightly contains carbon in order to impart oxidation resistance thereto. A diffusion coefficient of carbon into Ni at temperature of around 950° C. is extremely large. However, the carbon diffused in Ni is removed as CO₂ gas from the inside of the base material by oxidation heat treatment. Therefore, it is needless to say that the element such as carbon or phosphorus is removed by oxidation heat treatment from the base material and thus, is harmless if contained in the non-magnetic alloy or Ni layer.

Note that, the superconducting layer is directly formed on the NiO layer in the respective embodiments, but the present invention is not limited to this. It is possible that the Ag group metal layer is coated on the surface of the NiO layer and the superconducting layer is formed thereon, or the superconducting layer is formed on the NiO layer and the Ag group metal layer is coated thereon. With this arrangement, usage at 4.2 K also becomes possible. Also, by coating the Ag group metal layer thereon, such an advantage that the mechanical strength and the adhesive power of the porous NiO layer are improved is obtained. The above-mentioned coating can be easily performed by applying and baking the Ag group paste.

According to present invention, the non-magnetic metal base material for oxide superconducting thick films having a high strength and a low production cost can be provided.

1. A metal base material for oxide superconducting thick films, characterized in that an NiO layer is formed on at least one surface of a plate-shaped, tape-shaped, rod-shaped or wire-shaped non-magnetic alloy.

2. A metal base material for oxide superconducting thick films as set forth in claim 1, characterized in that the non-magnetic alloy contains as main components copper and nickel, and the nickel content is 10 wt. % or more and 49 wt. % or less.

3. A metal base material for oxide superconducting thick films as set forth in claim 1, characterized in that the non-magnetic alloy contains as the main components nickel and chromium, and the chromium content is 10 wt. % or more and 25 wt. % or less.

4. A metal base material for oxide superconducting thick films as set forth in claim 1, characterized in that the non-magnetic alloy contains tungsten as the main component.

5. A metal base material for oxide superconducting thick films as set forth in claim 1, characterized by containing at arbitrary ratios at least one kind of non-magnetic alloy selected from the group consisting of: a non-magnetic alloy containing as the main components copper and nickel, the nickel content being 10 wt. % or more and 49 wt. % or less; a non-magnetic alloy containing as the main components nickel and chromium, the chromium content being 10 wt. % or more and 25 wt. % or less; an alloy containing tungsten as the main component; molybdenum; manganese, and vanadium.

6. A metal base material for oxide superconducting thick films as set forth in any one of claims 1 to 5, characterized in that a content of iron in the non-magnetic alloy is less than 0.1 wt. %.

7. A manufacturing method for a metal base material for oxide superconducting thick films, characterized by comprising the steps of: (1) introducing a composite metal base material having an Ni layer joined on at least one surface of a plate-shaped, tape-shaped, rod-shaped or wire-shaped non-magnetic alloy into a furnace having an oxidative atmosphere, and heating/maintaining the alloy for a given period of time to subject the Ni layer to an oxidation reaction; (2) cooling the composite base material or changing the atmosphere into a vacuum or an inert atmosphere, to thereby suspend the oxidation reaction; and (3) after the step (2), heat-treating the composite metal base material under the vacuum or the inert, to thereby eliminate an Ni group ferromagnetic layer, and to uniformize a composition of a non-oxidized alloy layer.

8. A manufacturing method for a metal base material for oxide superconducting thick films, characterized by comprising the step of: introducing a composite metal base material having an Ni layer joined on at least one surface of a plate-shaped, tape-shaped, rod-shaped or wire-shaped non-magnetic alloy into a furnace having an oxidative atmosphere, and heating/maintaining the alloy for a period of time so that the Ni layer is entirely oxidized.

9. A manufacturing method for a metal base material for oxide superconducting thick films as set forth in claim 7 or 8, characterized in that the composite metal base material before being subjected to heat treatment is an Ni clad non-magnetic alloy.

10. A manufacturing method for a metal base material for oxide superconducting thick films as set forth in claim 7, characterized in that the composite metal base material before being subjected to heat treatment is an Ni and Ni poor non-magnetic alloy clad non-magnetic alloy.

11. A metal base material for oxide superconducting thick films, characterized in that the non-magnetic alloy is coated with a ceramics powder collective layer, and the ceramics powder collective layer is further coated with an NiO layer.

12. A manufacturing method for a metal base material for oxide superconducting thick films, characterized by comprising the steps of: inserting a non-magnetic alloy rod into an Ni tube; filling ceramics particles between the Ni tube and the non-magnetic alloy rod; processing the composite rod into a targeted shape so that a cross-sectional area of the composite is gradually decreased; forming a composite having an Ni layer on its surface; and subjecting the composite to high temperature oxidization to oxidize the entire of the Ni layer.
